(19) United States
(12) Patent Application Publication
(10) Pub. No.: US 2007/0194940 A1
(43) Pub. Date: Aug. 23, 2007

(54) Method and system for communicating travel alerts to mobile devices

(76) Inventor: Kalpana Valluru, Mansfield, MA (US)

Correspondence Address: KEVIN FARRELL;PIERCE ATWOOD, ONE NEW HAMPSHIRE AVENUE, PORTSMOUTH, NH, 03801, US

(21) Appl. No.: 11/655,404

(22) Filed: Jan. 19, 2007

Related U.S. Application Data
(60) Provisional application No. 60/766,472, filed on Jan. 21, 2006.

(51) Int. Cl. G08B 23/00; G08B 29/00; G08B 21/00

(52) U.S. Cl. 340/573.4; 340/506; 340/540

(57) ABSTRACT

The present invention is directed to an improved method of communicating a travel alert to at least one mobile device on a travel route affected by the travel alert. The method comprises pushing a travel alert to at least one mobile device from a command center in selective communication with the at least one mobile device which may communicate with the command center through a mobile network rather than through the computer network. This method further comprises receiving a communication from a user terminal selectively linked to an organization terminal via the computer network, wherein the communication comprises at least one travel parameter associated with the at least one mobile device. The method then comprises the step of executing a software portion in response to a travel alert, wherein the software portion analyzes the travel alert and the step of automatically communicating the travel alert to the at least one mobile device if at least one travel parameter is associated with the travel alert.

### CROSS REFERENCES

The present application claims the benefit of Provisional Application No. 60/766,472 filed on Jan. 21, 2006.

### BACKGROUND OF THE INVENTION

1. Field of the Invention

The present invention relates generally to the field of travel alert systems and methods and more particularly to a system and method that enables commuters disposed along a transit route to send and receive real-time updates and alerts of travel conditions from mobile devices having no access to a computer network.

2. Discussion of Background Information

Transit systems, such as train lines, buses, ferries, subway lines and trolleys, often incur delays or cancellations along their preplanned routes. Commuters relying on these transit systems experience unfortunate results caused by these delays or cancellations. For example, these interruptions may cause commuters to miss appointments or suffer during inclement weather while waiting at an outdoor transit stop.

To help mitigate these unforeseen events, most transit systems provide websites detailing schedule information for particular routes and vehicles along those routes including status information regarding whether a route or vehicle is running with or without interruption. Commuters may access these websites from a web-enabled device prior to departure or during transit, but often commuters are unaware of these transit websites. In addition, some commuters travel without web-enabled devices and therefore have no access to these transit authority websites during their commute when acquiring delay information is most useful.

In addition to allowing access to a limited number of devices, these transit authority websites and other transit authority arrival and departure boards generally experience latency in displaying or updating travel alerts regarding interruptions. Additionally, these sources of publicly available information often fail to communicate any related useful information like delay duration or causes. Systems for alerting commuters of travel interruptions along a particular travel route often rely on monitoring publicly available information on these websites and arrival and departure boards. These travel alert systems therefore experience latency in delivering travel alerts and they fail to indicate to commuters possible expected interruption duration.

Other travel alert systems require special equipment for tracking vehicles along a travel route. These systems require that a commuter access a website to provide copious detailed information including a departure location, an arrival location, any locations passed in between the departure location and arrival location and expected times for reaching each of these endpoint and intermediary locations. These notification systems then log delays and calculate subsequent delays based upon known distances between locations along a travel route. For example, some travel alert systems register delays at one location using GPS or radio frequency transmitter devices installed on each transit vehicle. By comparing expected arrival time and actual arrival time at a delayed location, these systems calculate an expected time at which each transit vehicle should arrive at a subsequent location positioned at some known distance from the delayed location. These calculations, however, often fail to account for variables associated with a particular interruption and thus provide commuters with unreliable and useless predictions. These systems are also costly and often limited in range.

Other travel alert systems require a monetary investment from commuters. These systems require that the consumer purchase and install on their mobile devices custom software for registering delay information and calculating predicted interruption periods. These systems are costly, and they inflict an additional layer of difficulty upon a commuter implementing the alert system.

For the aforementioned reasons, a need exists for a commuter travel alert system that provides reliable real-time data to commuters having no access to website information while traveling and that eliminates any potential cost or technology impediments to implementation.

### SUMMARY OF THE INVENTION

The present invention is directed to an improved method and system for alerting commuters to an interruption in service on a public transportation route, such as but not limited to a bus line, train line, subway line, ferry route, or trolley line.

In one embodiment the computer implemented method comprises pushing a travel alert to at least one mobile device from a command center in selective communication with one or more external devices communicatively linked with the command center. The command center comprises an organization terminal communicatively linked to a computer network wherein the organization terminal comprises a memory portion and a processor portion and wherein the memory portion contains therein a software portion executable by the processor. The command center optionally may comprise a telephonic communications device for sending and receiving calls and text messages. This method further comprises receiving a communication from a user terminal selectively linked to the organization terminal via the computer network, wherein the communication comprises at least one travel parameter associated with the at least one mobile device. The method also comprises storing in the memory portion the at least one travel parameter associated with the at least one mobile device, and receiving a travel alert in an email, a text message, or a telephone call from at least one source communicatively linked with the central command center. The method then comprises the steps of executing the software portion in response to the travel alert, wherein the software portion analyzes the travel alert to determine whether the at least one parameter is associated with the travel alert. An alert then issues at the method step of automatically communicating the travel alert to the at least one mobile device if the at least one travel parameter is associated with the travel alert.

Another embodiment of the computer implemented method of the present invention comprises providing a command center in selective communication with one or more external devices. The method also comprises receiving a communication from a user terminal selectively linked to an organization terminal at the command center via the computer network, wherein the communication comprises travel route and contact information associated with a first mobile device which has no direct access to the computer network and which is communicatively linked with the command center for receiving a travel alert in a text message format. The method further comprises storing in a memory portion of the user terminal the travel route and contact information associated with the first mobile device, receiving a travel alert from at least one source communicatively linked with the central command center, and executing the software portion. In response to receiving the travel alert, the software portion of the command center analyzes the traffic alert to determine whether the travel route information is affected by the travel alert. The method further comprises automatically communicating the travel alert to the first mobile device if the travel route information is affected by the traffic alert.

An embodiment of the system of the present invention for communicating a travel alert to at least one mobile device on a travel route affected by the travel alert comprises a computer network communicatively linking a plurality of external terminals to a registry for storing travel route information and contact information associated with a plurality of mobile devices having no direct communication with the computer network. The system further comprises a centralized command center that receives travel alerts from external sources and communicates with the registry to identify mobile devices in the registry having associated travel route information including a travel route affected by the travel alert. The centralized command center is communicatively linked with the mobile devices, which enable the centralized command center to push the travel alert to mobile devices identified in the registry as having associated travel route information affected by the travel alert.

These and other features, aspects, and advantages of the present invention will become better understood with reference to the following description, appended claims, and accompanying drawings where:

### BRIEF DESCRIPTION OF THE DRAWINGS

FIG. 1a is a schematic showing an overview of an embodiment of the system present invention.

FIG. 2a is a flow diagram of one aspect of an embodiment of the present invention.

FIG. 2b is an exemplary embodiment of a graphical user interface representing one aspect of the present invention.

FIG. 2c is an exemplary embodiment of a graphical user interface representing another aspect of an embodiment of the present invention.

FIG. 2d is an exemplary embodiment of a graphical user interface representing another aspect of the present invention.

FIG. 2e is an exemplary embodiment of a graphical user interface representing another aspect of the present invention.

FIG. 3 is a flow diagram of an embodiment of the method the present invention.

FIG. 4 is a depiction of an exemplary embodiment of a graphical user interface representing another aspect of the present invention.

FIG. 5 is a depiction of an exemplary embodiment of a graphical user interface representing another aspect of the present invention.

FIG. 6 is a depiction of an exemplary embodiment of a graphical user interface representing another aspect of the present invention.

FIG. 7 is a depiction of an exemplary embodiment of a graphical user interface representing another aspect of the present invention.

### DETAILED DESCRIPTION

The present invention resolves the stated deficiencies of typical travel alert systems and methods, and provides effective tools for automatically pushing actual alerts, rather than predictions, of interruptions to commuters in real time without requiring a contemporaneous prompt from the commuter and without requiring that commuters carry web-enabled devices during their commutes.

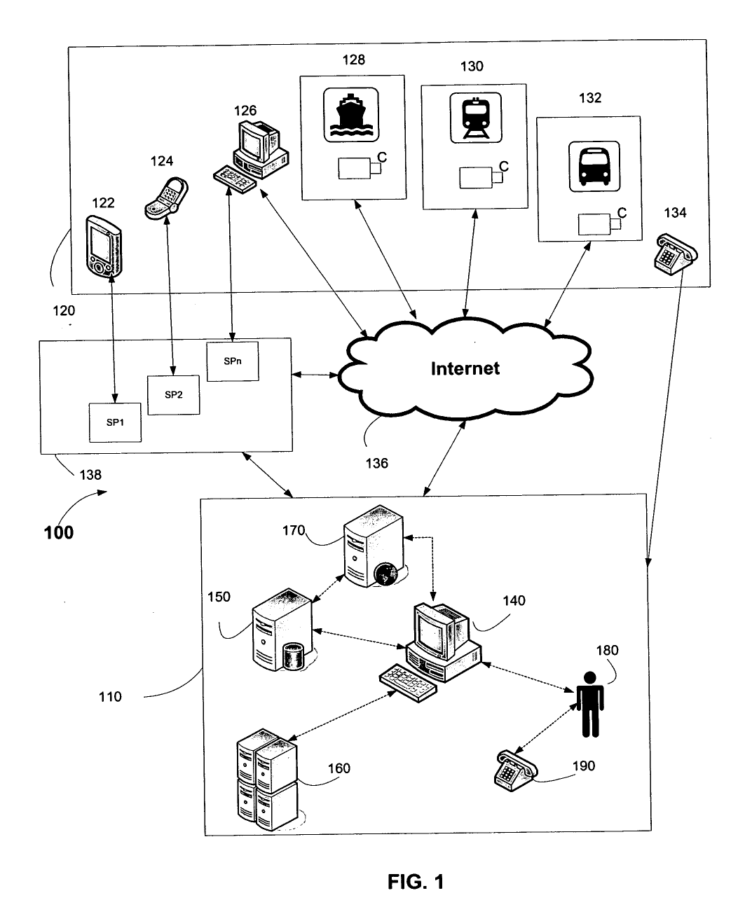

FIG. 1 depicts an embodiment of the travel alert system 100 of the present invention. A command center 110 for monitoring travel alerts is communicatively linked to a number of terminal systems 120 for either transmitting and/or receiving information. These terminal systems 120 include mobile devices adapted to receive or send communications over one or more communication networks, devices such as personal computing devices or personal digital assistants (PDA) 122, mobile phones 124, pagers (not shown), or laptop computers (not shown). These terminal systems 120 also include stationary devices such as stationary computer terminals 126 and landline telephones 134. Other terminal systems 120 communicatively linked with the command center may include a plurality of transportation authority communication systems such as a ferry system 128, a train or subway system 130, or a bus system 128. Each of these systems may comprise a website providing schedule information and optionally may comprise a web enabled camera aimed at an arrival and departure board.

Terminal systems 120 may communicatively link to the command center 110 through a computer network, such as the Internet 136, but in a preferred embodiment depicted in FIG. 1, mobile devices 122, 124 require no direct communication with the command center via the Internet 136. These devices may communicate directly with command center 110 via a mobile device network provided by one of a plurality of associated service providers 138. For example, rather than relying on TCP/IP data transmission protocols or SMTP or any other available protocol for short messaging services, these service providers 138 provide cellular towers for sending and receiving satellite transmissions of data to and from the mobile devices 122, 124.

Turning now to the command center 110 depicted in FIG. 1a, the present invention comprises an organization terminal 140 for communicating with the terminal devices 120 to receive and send travel alerts. The command center also optionally comprises an encrypted database server, or registry, an application server 160, a web server 170, at least one manual operator 180 and preferably a plurality of operators 180 comprising help desk operators and quality assurance operators. The command center 110 also may comprise a telephone 190 adapted for receiving both standard landline calls and digital or voice over IP (VOIP) telephone calls from the plurality of terminal devices 120.

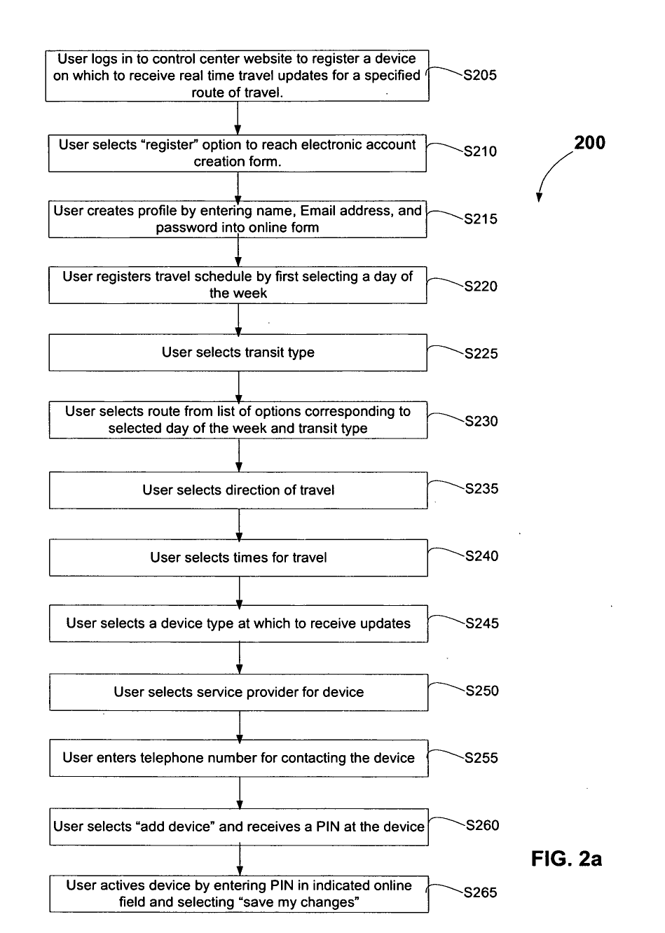

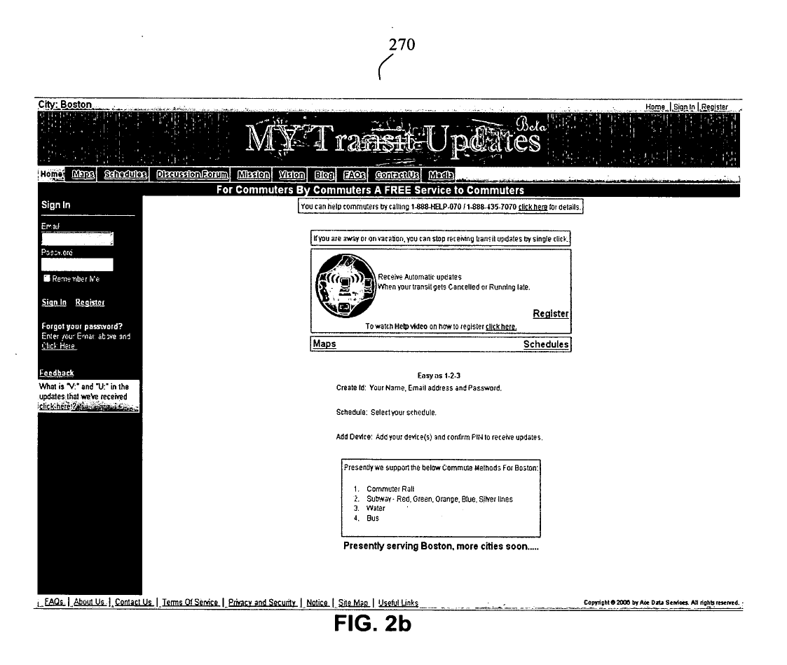

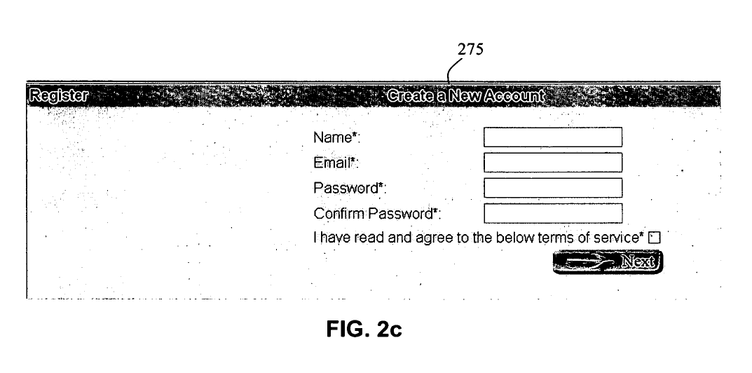

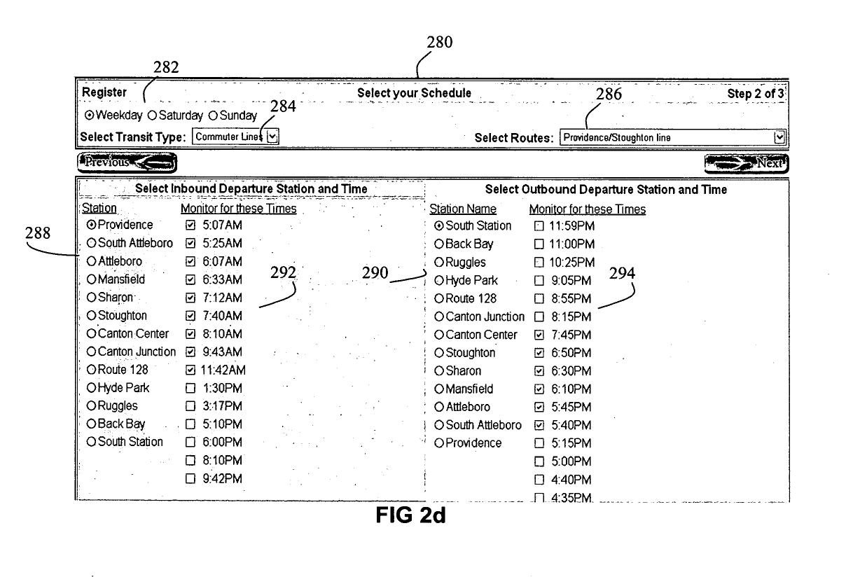

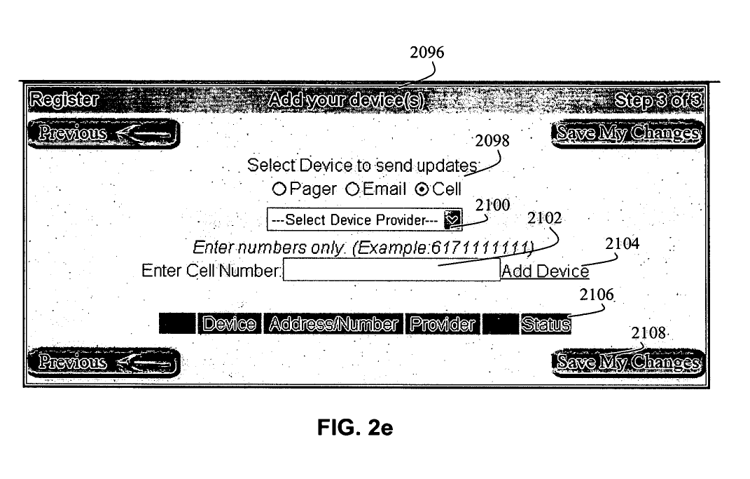

FIG. 1 also depicts a computer network 136 for use with registering a mobile device 122, 124 with the command center 110. FIGS. 2a through 2e address one element of an embodiment of the method of the present invention, which element comprises a registration process 200 for registering a mobile device 122, 124 or a stationary terminal device 126, 134 with the command center 110. Because the present invention is available on a global level, and because the Internet 136 is a global electronic communications network linking private and public networks and computers, the Internet 136 is an appropriate medium for facilitating the registration element of the present invention. Other less expeditious, manual means for registering a mobile device 122, 124 with the command center 110 are available nonetheless. Such means include, for example, manually writing or telephoning the command center 110 with contact information associated with a mobile device 122, 124 and with any associated preference information for receiving automated travel alerts. In those instances, the command center 110 may be manually operated by one or more operators who receive telephoned and printed information and then log that information manually to a tangible storage medium or registry, such as the encrypted electronic database server 150.

Preferably, though, the improved method of the present invention operates using electronic means in accordance with a computer network system shown in FIG. 1. The device information and travel preferences associated with a mobile device 122, 124 remain in an electronic data storage location, preferably a database server 150 adapted for storing databases, or registries, of information. This encrypted database server 150 provides an added level of security and more expansive storage capacity. In a preferred embodiment, this database server 150 connects directly to the Internet 136. Alternatively, the database server 150 may communicate with the Internet 136 via the organization terminal 140 or via the web server 170.

The organization terminal 140 is preferably a computer that comprises elements typical of a computing system. These elements include items such as a monitor, a keyboard, a processor such as a central processing unit (CPU), and a memory storage area. The memory storage area may be random access memory (RAM), or a combination of RAM and some removable memory storage means such as floppy disk, EPROMs, PROMs, or USB storage devices. The memory storage area contains computer readable code, or software, for performing tasks such as reconciling delay information with mobile device route information and alert preferences. In an alternative embodiment, the organization terminal 140 optionally may communicate with an application server 160 that stores and executes the software and with a web server 170 that hosts an interactive website through which the terminal devices 120 communicatively linked to the Internet 136 relay registration information to the command center 110.

Bi-directional routers (not shown) also may be disposed between each of the plurality of terminal devices 120 and the Internet 136, and between the Internet 136 and the command center 110. An unlimited number of terminal devices 120 therefore may access the command center 110 via the Internet 136 to register contact and travel information associated with a plurality of mobile devices 122, 124.

Turning now to the registration element of the present invention, FIGS. 2a through 2e detail one embodiment of the registration process 200 of present invention. This registration process 200 comprises registering one or more mobile devices 122, 124, such as PDAs, mobile phones, or pagers, on which to receive and optionally send, real time travel updates over a mobile network without having to access the Internet 136. This registration process 200 also may comprise registering a plurality of stationary devices such as computer terminals 126 and landline telephones 134. These devices may associate with a new or an existing customer account.

In a first registration step S205 of this registration process 200, a commuter initiates creation of a user account by logging into a website associated with the control center 110 from a terminal device 120 that is communicatively linked with the Internet 136. In a subsequent step (not shown), the command center web site may recognize the user's terminal device 120 having enabled identification means such as cookies, and thus the command center 110 software automatically may identify a user's preferred travel city. Alternatively, a user may select from a list (not shown) a city in which to receive travel alerts. As depicted in the exemplary graphical user interface of FIG. 2b, the command center 110 provides a website interface 270 comprising a link to an account creation form 275 illustrated in FIG. 2c. In an account creation step S215, the user creates an account stored at the database server 150 by entering into the account creation form 275 any requested personal information, for example a name, an email address and a password. Next, in a plurality of schedule selection steps S220 through S240, a user enters one or more additional travel preferences on a redirected interactive schedule selection page 280 such as the exemplary page depicted in FIG. 2d.

In this embodiment, in a day selection step 220, a user selects one of a plurality of radio buttons 282 indicating a day of travel. From a transit type drop down menu 284, a user may select at a transit selection step 225 a particular transit type, such as a commuter rail line, bus line or ferry line. From a route drop down menu 286, a user then may select at a route selection step 230 a preferred route on which to travel. The user then identifies a preferred direction of travel and starting point of travel at a departure location selection step 235 by selecting a departure stations from either an inbound station selection list 288 or an outbound station selection list 290. The user then may select at a time selection step 240 one or more preferred times of travel from either an inbound departure time list 292 or an outbound departure time list 294. In an alternative embodiment, a user may select more than one station from the station lists 288, 190 and more than one associated departure times from the time list 292, 294.

After entering travel preferences, a user then adds one or more mobile devices 122, 124 to the user account by entering device contact information on a redirected device identification page 2096 depicted in FIG. 2e. Optionally, the user also may add one or more stationary terminal devices 120, such as a computer terminal 126 or a landline telephone 134. Here, at a device selection step S245 in the registration process 200, a user first selects a device type 2098 from a plurality of listed device types 2098 on which to receive travel alerts or travel alert updates. Next, at a device provider selection step S250, a user selects a device provider associated with the mobile device 122, 124 from a provider drop down menu 2100. In an alternative embodiment, this device provider selection step 250 is optional.

Next, at a number entry step S255, a user enters a mobile number into a cell number field 2102. At an add device step S260, the user selects the add device option 2104 to add the device to the user account and prompt the command center 100 to deliver a unique identification number, or PIN, to the mobile device 122, 124 associated with the mobile number entered into the cell number field 2102 in the number entry step S255. Optionally, the user may provide an email address or a telephone number on the device identification page 2096 and receive the PIN at a stationary terminal such as a stationary computer 126 or a landline telephone 134 for registering a terminal device 120.

Returning now to the present embodiment of the registration process 200, the redirected device page 2096 preferably provides a display field 2106 for displaying the selected device type 2098, the mobile number entered into the cell number field 2102, the device provider selected from the provider drop down menu 2100, and a registration status. This display field 2106 may display more than one mobile device 122, 124 associated with a user account and the user may register additional mobile devices by repeating steps S245 through S260. In a final registration step S265, the user actives the mobile device 122, 124 now registered with the database server 150 by entering the device PIN into a PIN field (not shown) in form 2096. By selecting a “save my changes” toggle button 2108, the user finalizes the registration process 200. In another embodiment, form 2096 may be adapted to receive an email address also associated with the mobile device 122, 124 for use with web-enabled protocols. In a preferred embodiment, this additional process step is unnecessary for receiving real time travel alerts at a mobile device 122, 124 which is communicatively linked with the command center 110.

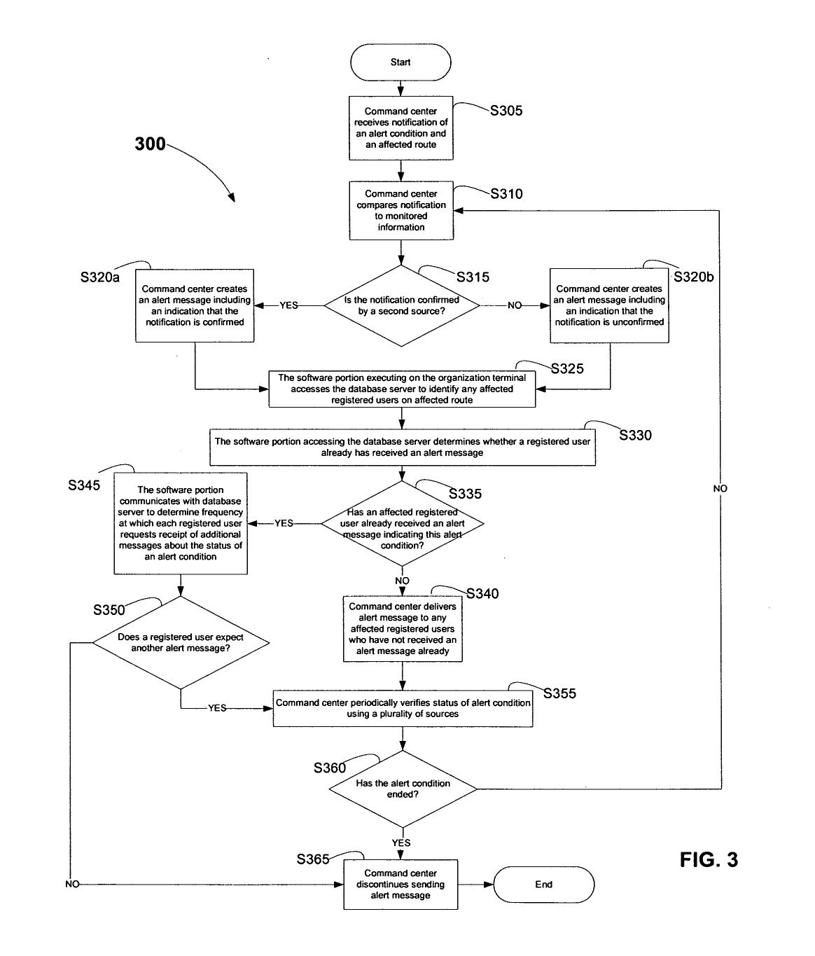

Once a commuter completes the registration process 200 for one or more mobile devices 122, 124, the command center 110 will push alerts to that device without requiring a prompt from the user. FIG. 3 is a flowchart depicting the simple, effective and reliable alert process 300 by which the command center 110 of the system 100 of the present invention receives and communicates real time travel alerts to registered users. The alerts are communicated to a plurality of mobile devices 122, 124 and particularly to a plurality of mobile devices 122, 124 having no access to the Internet 136 for retrieving or requesting travel information from publicly available websites. In an alternative embodiment, the command center 110 also may push these alerts to a plurality of stationary devices such as a computer terminal 126 communicatively linked with the Internet 136 or a landline telephone 134. This push service, however, is particularly useful for commuters in transit who require real-time notification of travel alerts addressing delays or service interruptions along one or more preferred travel routes who have no access to the Internet 136. Additionally, this command center 110 is adapted to receive real-time alerts from a plurality of mobile devices 122, 124 associated with commuters in transit who are most aware of current travel conditions and who also may have no access to the Internet 136.

At the first stage 305 of the alert process 300, the command center 110 receives a notification of an alert condition and an affected travel route from one or more sources or originating terminal devices 120. The affected travel route may be actively communicated or tacitly communicated if an originating terminal device 120 is an identifiable mobile device 122, 124 registered with the command center 110 and having a limited set of registered travel preferences. In this later instance, the command center 110 recognizes the mobile device 122, 124 by its mobile number and retrieves travel preferences associated with this mobile device from the registry 150. The travel alert notification may be in any real-time communication format, for example an email, a telephone call, or a text message.

In a preferred embodiment, the one or more originating terminal devices 120 communicating a travel alert notification to the command center 110 are mobile devices 122, 124 associated with commuters waiting for or traveling on vehicles associated with the public transit types and located along associated routes identified in the route drop down menu 286. The notification may include any number of elements including, for example, delay length, cause or subsequent resolution. In the present embodiment, the command center 110 also monitors publicly available information, such as scheduling information and delay notices posted on transit authority websites. A transit authority may use one or more devices or methods to track the location of one more transit vehicles. These tracking devices are, for example, GPS or radio frequency transmitters and receivers that may produce real-time data. The command center 110 also may monitor this publicly available data.

At a second process step 310, the software portion of the command center 110 executes and polls for publicly available information over the Internet 136. The software portion compares the notification of an alert condition to the polled information. In a first decision step S315, the command center 110 decides whether the alert is confirmable by a second source, such as the publicly available information. If the notification information reconciles with publicly available information, at a third process step S320a, the command center 110 creates an alert message for subsequent distribution to registered mobile devices 122, 124 that includes an indication of verification. If the command center 110 is unable to reconcile this notification against publicly available information such as that stored on transit authority monitoring servers and displayed at transit authority websites, at an alternative third process step S320b the command center 110 creates an alert message that includes an indication that the alert is unverified. In a preferred embodiment, the indication of verification is a “V:” preceding the alert message and the indication of an unverified alert message is an “U:” preceding the alert message. This verification process is optional, but a preferred embodiment of the present invention preferably employs this process to insure reliability.

In an alternative embodiment an operator 180 or a plurality of operators 180 comprise a help desk portion of the command center 110. The plurality of operators 180 may monitor the publicly available information and manually reconcile received notifications of travel alerts against that publicly available information. The plurality of operators 180 may use one or more organization terminals 140 to monitor scheduling information and travel alerts posted at transit authority websites. The plurality of operators 180 may also monitor live video feeds from a plurality of video cameras trained at arrival and departure boards displayed at transit platforms for providing alert updates to commuters waiting on those platforms. These video feeds may be hosted either by the command center 110 on the web server 170 or by the transit authority systems 128, 130, 132. These sources of information are otherwise unavailable to commuters in the process of traveling and having no access to the Internet 136.

In yet another embodiment of the present invention, the software portion of the command center 110 may automatically monitor publicly available information and produce at the organization terminal 140 one of three auditory signals. In this alternative embodiment, a first auditory signal indicates identification of a publicly posted alert condition. A second auditory signal indicates a change in a pending alert condition. The software may periodically instruct the organization terminal to issue a third auditory alert indicating no change in an alert condition. This auditory system provides the plurality of operators 180 with a reliable method for identifying a travel alert for distribution to affected registered mobile devices 122, 124 and also may provide an additional method for verifying of notifications.

Returning to the preferred embodiment of FIG. 3, the command center 110 preferably comprises a plurality of operators 180 who receive or perceive a notification of an alert. In response to that notification, at the third process step 320a or the alternative third process step 320b, the plurality of operators 180 prepare a succinct alert message for distribution to registered mobile devices 122, 124 having travel preferences associating the mobile device 122, 124 with a travel route affected by the alert. Alternatively, the software portion of the command center 110 may automatically create a notification for distribution. Preferably though, a plurality of operators 180 at the command center 110 provide the added value of quality control by attempting to verify the received notification and by preparing a user friendly message for real time distribution.

At a fourth step S325 in the embodiment of the alert process 300 depicted in FIG. 3, the software portion executing on the organization terminal 140 accesses the database server 150 to identify any registered mobile devices 122, 124 potentially disposed along the affected route or pending arrival along the affected route. The command center selectively will communicate the prepared alert message identifying the alert condition and an affected travel route to a plurality of registered mobile devices 122, 124 and stationary devices 126, 134 having travel preferences stored in the registry 150 that coincide with the affected travel route. These registered travel preferences also may comprise a pre-selected time frame within which to receive alert messages.

In a preferred embodiment, before delivering the travel alert, the software portion also communicates at a sixth step S330 with the database server 150 to determine whether a registered mobile device 122, 124 already has received the prepared alert message. At a second determination step S335 of this embodiment, the command center 110 executes the software portion for again polling the registry or database server 150 to locate any recorded indications associated the plurality of registered mobile devices 122, 124 that previously may have received the prepared alert message. If a mobile device 122, 124 has received this prepared alter message already, the software portion continues to execute on the organization terminal 140, and at a seventh step S340, the command center 110 delivers the prepared travel alert message to affected registered mobile devices 122, 124, that have not received an alert message already. In an alternative embodiment of the alert process 300 of the present invention, a travel alert also issues to a plurality of stationary terminal devices 120, such as a computer terminal 126 and a landline telephone 134.

If the software portion determines at the second determination step S335 that a user has received this alert message already, the software portion continues to access the database server 150. At an eighth step S345 in this embodiment of the method of the present invention, the software portion determines whether a registered mobile device 122, 124 has a registered preferred frequency at which to receive additional messages about the status of an alert condition. At a third decision step S350 immediately succeeding the eighth step S345, the command center 110 determines whether a registered mobile device 122, 124 expects another alert message.

Both the third decision step S350 and the seventh step S340 proceed to a ninth step S355 at which the command center periodically or continuously attempts to verify the status of the alert condition against a plurality of publicly available sources of information as described in relation to the second step S310. Determining at the third decision step S350 that a registered mobile device 122, 124 expects an alert message prompts the command center 110 to verify the status of the alert condition. Determining at the third decision step 350 that a registered mobile device expects no other alert messages pertaining to this travel alert prompts the command center 110 to discontinue sending alert messages pertaining to this alert condition, as indicated in the final process step S365. If the command center 110 determines at the ninth step 360 that an alert condition has ended the system also proceeds to this final process step S365. Otherwise, if the command center 110 determines at the ninth step 355 that an alert condition persists or otherwise has changed status, the command center 110 will return to the second step S310 in the alert process 300.

The alert process 300 is configurable for responding to a plurality of registered preferences. Other registered preferences associated with a registered mobile device 122, 124 may include, for example, criteria for receiving an alert only if the alert comprises an interruption greater than an indicated duration. In yet another embodiment, the process 300 may include an incentive for encouraging commuters to deliver real time notifications to the command center 110 for distribution to other registered terminal devices 120. In this alternative embodiment, the database server 150 may associate a credit with a customer account associated with one or more registered terminal devices 120 that delivers a timely travel alert notification that the command center 110 simultaneously or subsequently verifies as accurate. This credit process may operate similar to other systems logging credits redeemable for rewards. This alternative embodiment may provide a disincentive also for providing false alerts wherein credits are removed from an account associated with a registered terminal device 120 proving a false notification.

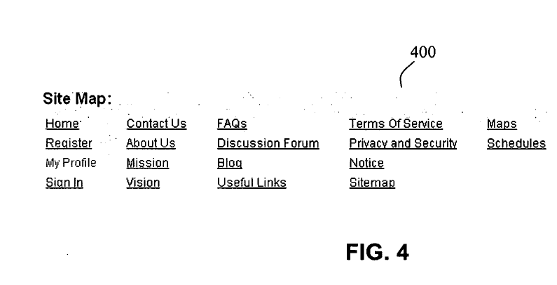

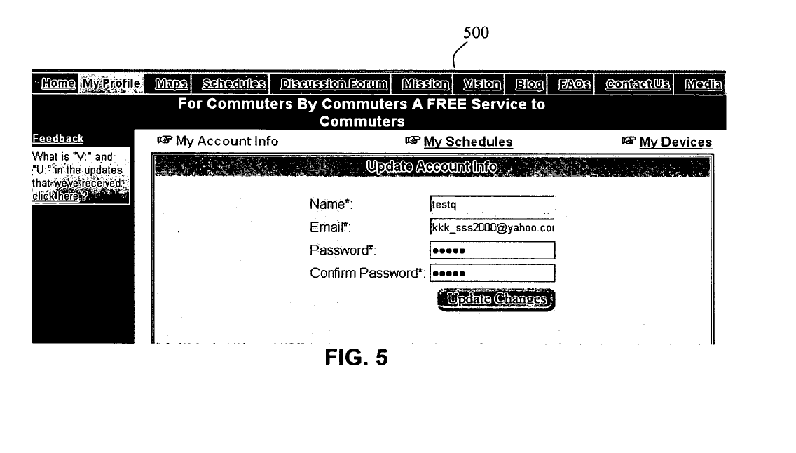

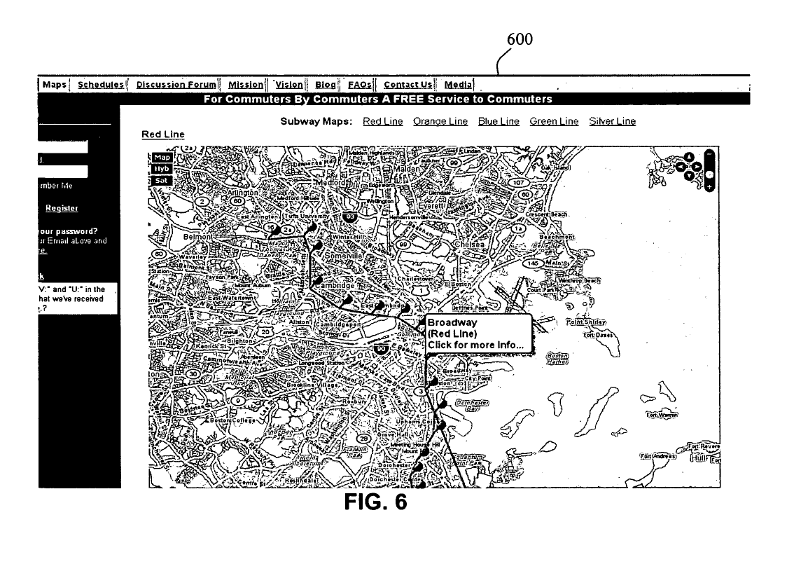

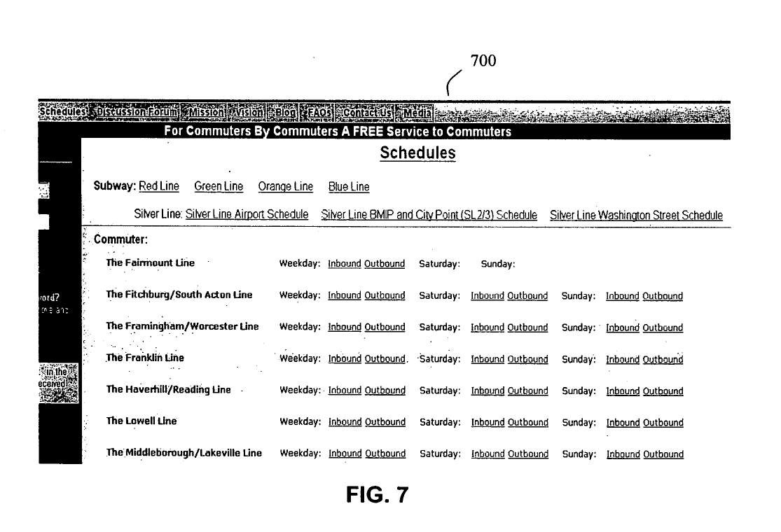

FIGS. 4 through 7 depict exemplary embodiments of graphical user interfaces associated with the command center website, which is preferably hosted by the web server 170 and publicly accessible over the Internet 136. The command center website includes travel alert information available to terminal devices 120 communicatively linked with the command center 110 over the Internet 136. FIG. 4 illustrates a site map 400 comprising hyperlinks for navigating the command center website. FIG. 5 depicts an interactive account form 500 for altering or updating account information. FIG. 6 depicts a map 600 indicating a highlighted transit route. FIG. 7 depicts a transit authority schedule 700 assembled by the command center 110 from publicly available sources of information.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1. A computer implemented method for pushing a travel alert to at least one mobile device, comprising:
a) providing a command center in selective communication with one or more external devices, wherein the command center comprises:
i) an organization terminal communicatively linked to a computer network wherein the organization terminal comprises a memory portion and a processor portion and wherein the memory portion contains therein a software portion executable by the processor; and
ii) an optional telephonic communications device;
b) receiving a communication from a user terminal selectively linked to the organization terminal via the computer network, wherein the communication comprises at least one travel parameter associated with the at least one mobile device;
c) storing in the memory portion the at least one travel parameter associated with the at least one mobile device;
d) receiving a travel alert in an email, a text message, or a telephone call from at least one source communicatively linked with the central command center; and
e) executing the software portion in response to the travel alert, wherein the software portion analyzes the travel alert to determine whether the at least one parameter is associated with the travel alert; and
f) automatically communicating the travel alert to the at least one mobile device if the at least one travel parameter is associated with the travel alert.

2. The method of claim 1, further comprising analyzing said travel alert to verify accuracy against a transit authority's publicly available information prior to communicating the traffic alert to the at least one mobile device.

3. The method of claim 2, further comprising including an indication in the travel alert as to whether the travel alert is verified or unverified against a transit authority's publicly available information.

4. The method of claim 1, wherein the at least one mobile device is in communication with the computer network via wired or wireless means and wherein the at least one mobile device communicates with the command center over the computer network.

5. The method of claim 4, wherein the travel alert is communicated to the at least one mobile device in an email format.

6. The method of claim 4, wherein the travel alert is communicated to the at least one mobile device in a text message format.

7. The method of claim 1, wherein the at least one mobile device has no access to the computer network.

8. The method of claim 7, wherein the travel alert is communicated to the at least one mobile device in a text message format.

9. The method of claim 1, wherein the at least one source of the travel alert is a mobile terminal having access to the computer network.

10. The method of claim 1, wherein the at least one source is a mobile terminal having no access to the computer network.

11. The method of claim 1, wherein the at least one source is a transit authority's website communicatively linked with the command center via the computer network.

12. The method of claim 11, wherein the transit authority's website includes travel alerts.

13. The method of claim 11, wherein the transit authority's website includes a video feed from a camera monitoring an arrival and departure board.

14. The method of claim 11, wherein the transit authority's website includes a video feed from a camera monitoring an arrival and departure platform.

15. The method of claim 1, wherein the source is a landline telephone.

16. The method of claim 1, wherein the source is a stationary terminal communicatively linked to the computer network.

17. The method of claim 1, wherein the at least one travel parameter is a metropolitan area.

18. The method of claim 17, further comprising receiving at least one additional travel parameter associated with the metropolitan area, wherein the at least one additional travel parameter is a transit type.

19. The method of claim 18, further comprising receiving additional transit information comprising a preferred departure location and at least one preferred departure time.

20. The method of claim 1, wherein the command center further comprises at least one server for storing the at least one travel parameter associated with the at least one mobile device.

21. The method of claim 1, wherein the command center further comprises at least one server for storing the software portion.

22. A computer implemented method for receiving a travel alert in real time and communicating that travel alert to a first mobile device, comprising:
a) providing a command center in selective communication with one or more external devices, wherein the command center comprises:
i) an organization terminal communicatively linked to a computer network wherein the organization terminal comprises a memory portion and a processor portion and wherein the memory portion contains therein a software portion executable by the processor; and
ii) an optional telephonic communications device;
b) receiving a communication from a user terminal selectively linked to the organization terminal via the computer network, wherein the communication comprises travel route and contact information associated with the first mobile device which has no direct access to the computer network and which is communicatively linked with the command center for receiving a travel alert in a text message format;
c) storing in the memory portion the travel route and contact information associated with the first mobile device;
d) receiving a travel alert from at least one source communicatively linked with the central command center; and
e) executing the software portion in response to the travel alert, wherein the software portion analyzes the traffic alert to determine whether the travel route information is affected by the travel alert; and
f) automatically communicating the travel alert to the first mobile device if the travel route information affected by the traffic alert.

23. The method of claim 22, wherein the at least one source is a second mobile device.

24. The method of claim 23, wherein the second mobile device has no direct access to the computer network.

25. The method of claim 24, wherein the second mobile device is pager capable of receiving and sending text messages.

26. The method of claim 24, wherein the second mobile device is a personal computing device capable of receiving and sending text messages.

27. The method of claim 24, wherein the second mobile device is a cellular telephone capable of receiving and sending text messages.

28. The method of claim 23, wherein the second mobile device is in direct communication with the computer network and wherein the second mobile device delivers the travel alert to the command center in an email format.

29. The method of claim 22, wherein the at least one source is publicly available information displayed on a website accessible by the organization terminal through the computer network.

30. The method of claim 22, wherein the travel route information comprises a city, a transit type, a route name, a starting location and direction of travel, and one or more times of expected travel.

31. An improved system for communicating a travel alert to at least one mobile device on a travel route affected by the travel alert, the system comprising:
a) a computer network communicatively linking a plurality of external terminals to a registry for storing travel route information and contact information associated with a plurality of mobile devices having no direct communication with the computer network; and
b) a centralized command center which receives travel alerts from external sources and communicates with the registry to identify mobile devices in the registry having associated travel route information including a travel route affected by the travel alert, the centralized command center being communicatively linked with the mobile devices enabling the centralized command center to push the travel alert to mobile devices identified in the registry as having associated travel route information affected by the travel alert.

32. The system of claim 31, wherein the plurality of external terminals are devices such as computers, personal computing devices, cell phones, or any other devices capable of accessing the computer network via wired or wireless means.

33. The system of claim 32, further comprising a server for storing the travel information associated with the mobile devices.

34. The system of claim 33, wherein the server stores one or more award credits associated with the mobile devices that deliver verified travel alerts.

35. The system of claim 31, wherein the travel alert originates from a mobile device disposed along the affected travel route.

36. The system of claim 31, wherein the travel alert originates from publicly available resources.
